(19) United States
(12) Patent Application Publication
(10) Pub. No.: US 2016/0321084 A1
(43) Pub. Date: Nov. 3, 2016

(54) NON-TRANSITORY COMPUTER READABLE RECORDING MEDIUM AND ELECTRONIC APPARATUS

(71) Applicant: KYOCERA DOCUMENT SOLUTIONS INC., OSAKA (JP)

(72) Inventors: SATOSHI IMAI, OSAKA (JP); DAIJIRO KITAMOTO, OSAKA (JP); AYAKA IKEJIMA, OSAKA (JP); WATARU TSUKUDA, OSAKA (JP); MINORU TAKAHASHI, OSAKA (JP)

(21) Appl. No.: 15/137,287

(22) Filed: Apr. 25, 2016

(30) Foreign Application Priority Data
Apr. 28, 2015 (JP) 2015-091228

(51) Int. Cl. G06F 9/44; G06F 9/445

(52) U.S. Cl. CPC G06F 9/4411; G06F 8/61

(57) ABSTRACT

An application package includes a device driver group including a plurality of different device drivers, each of the device drivers being programmed by a native code in correspondence with each of hardware environments, each of the hardware environments being different for each of electronic apparatuses, each of the device drivers being operated on an operating system of each of the electronic apparatuses, and a bytecode that is operated on a virtual environment of the electronic apparatus. The bytecode includes a first program code that causes a processor of the electronic apparatus to acquire information on the hardware environment, a second program code that causes the processor to search for a device driver corresponding to the acquired hardware environment out of the device driver group, and a third program code that causes the processor to install the retrieved device driver in the operating system.

### CROSS REFERENCE TO RELATED APPLICATIONS

This application claims the benefit of Japanese Priority Patent Application JP 2015-091228 filed Apr. 28, 2015, the entire contents of which are incorporated herein by reference.

### BACKGROUND

The present disclosure relates to an electronic apparatus that installs and uses programs that depend on hardware and a non-transitory computer readable recording medium onto which the programs are recorded.

Device drivers have generally been used as programs that control various types of hardware connected to electronic apparatuses and enable them to be used from versatile OS's (Operating Systems).

Previously, it has been necessary for a user to purchase and install a device driver in newly adding hardware to an electronic apparatus. Currently, however, less time and effort is needed for the user since an OS recognizes connected hardware and acquires and installs an appropriate device driver on its own.

However, there arises a problem in terms of usage of device drivers, and there is still room for more contrivances.

For example, external devices are connected to electronic apparatuses placed under various hardware environments. Therefore, it is desired for a device driver supporting an external device, that is to be installed in electronic apparatuses placed under various hardware environments, to be more user-friendly.

### SUMMARY

According to an embodiment of the present disclosure, there is provided a non-transitory computer readable recording medium onto which an application package is recorded. The application package includes a device driver group including a plurality of different device drivers, each of the device drivers being programmed by a native code in correspondence with each of hardware environments, each of the hardware environments being different for each of electronic apparatuses, each of the device drivers being operated on an operating system of each of the electronic apparatuses, and a bytecode that is operated on a virtual environment of the electronic apparatus. The bytecode includes a first program code that causes a processor of the electronic apparatus to acquire information on the hardware environment of the electronic apparatus, a second program code that causes the processor to search for a device driver corresponding to the acquired hardware environment out of the device driver group, and a third program code that causes the processor to install the retrieved device driver in the operating system.

According to an embodiment of the present disclosure, there is provided an electronic apparatus including: a processor that executes a bytecode operated on a virtual environment of the electronic apparatus; and an application package including a device driver group and the bytecode, the device driver group including a plurality of different device drivers, each of the device drivers being programmed by a native code in correspondence with each of hardware environments, each of the hardware environments being different for each of electronic apparatuses, each of the device drivers being operated on an operating system of each of the electronic apparatuses. The processor operates as, when the bytecode is executed, an environment determination circuit that acquires information on the hardware environment of the electronic apparatus, a device driver search circuit that searches for a device driver corresponding to the acquired hardware environment out of the device driver group, and a device driver install circuit that installs the retrieved device driver in the operating system.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a diagram for explaining a general outline of an embodiment of the present disclosure;

FIG. 2 shows a structure of an image forming apparatus 20;

FIG. 3 shows an example of a hardware environment table 1e of the image forming apparatus 20; and

FIG. 4 shows processing steps executed when setting a device driver in the image forming apparatus 20.

### DETAILED DESCRIPTION OF EMBODIMENTS

Hereinafter, an embodiment of the present disclosure will be described with reference to the drawings. It should be noted that in the descriptions below, an image forming apparatus (MFP; Multifunction Peripheral) is exemplified as an electronic apparatus.

(General Outline)

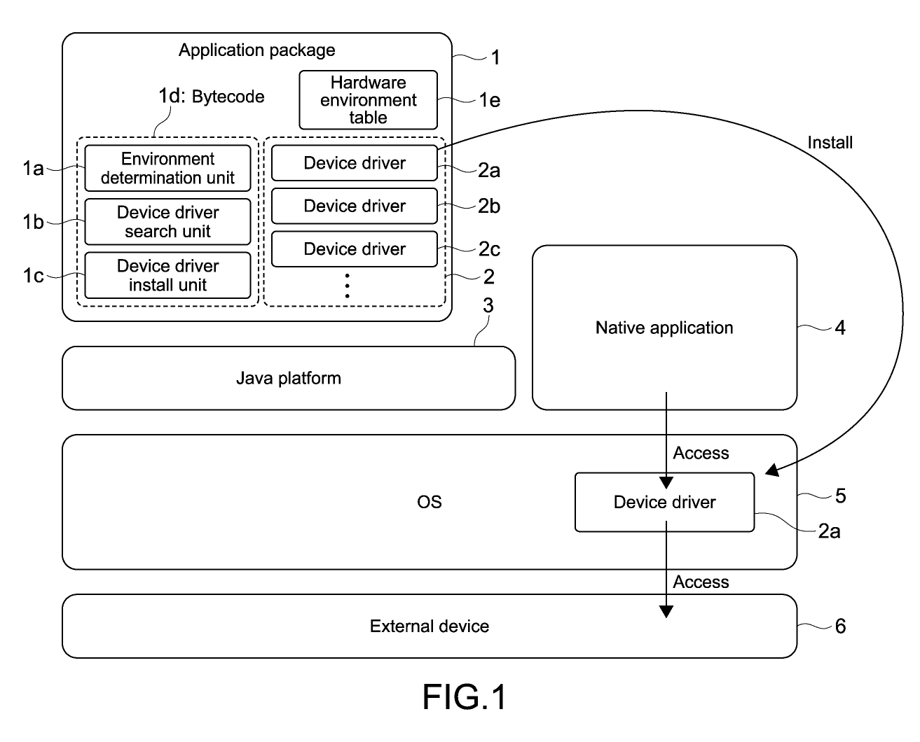

First, a general outline will be described. FIG. 1 is a diagram for explaining the general outline of the embodiment of the present disclosure.

An OS (Operating System) 5 operates in a controller (to be described later) of the image forming apparatus, and a native application 4 and a Java (registered trademark) platform 3 operate on the OS 5. The native application 4 is programmed in a native code in correspondence with a version of the OS 5 and a type of CPU (Central Processing Unit, processor) operating the OS 5 and the like. The Java platform 3 operates a Java application programmed in a bytecode so that it functions irrespective of the OS 5 version and the CPU type.

The Java platform 3 provides a bytecode-executable virtual environment that does not depend on hardware, on the OS 5 of the image forming apparatus.

An application package 1 according to the embodiment of the present disclosure includes a bytecode 1d that operates on the Java platform 3, a device driver group 2 including a plurality of different device drivers 2a, 2b, and 2c, and a hardware environment table 1e. Each of the device drivers 2a, 2b, and 2c is programmed in a native code in correspondence with an environment of one image forming apparatus (OS 5 version and CPU type). The application package 1 is recorded onto a non-transitory computer readable recording medium.

It should be noted that when a PC (Personal Computer) is used as the electronic apparatus, the number of types of the OS 5 and CPU becomes extremely large. As a result, it becomes difficult to prepare device drivers corresponding to those environments and incorporate them in the application package 1.

However, when assuming an image forming apparatus of a particular manufacturer as the electronic apparatus, the combinations of types of the OS 5 and CPU are limited, and thus it is realistically possible to prepare device drivers in a number corresponding to those combinations and incorporate them in the application package 1.

The bytecode 1d part of the application package 1 includes a first program code that causes the controller (to be described later) of the image forming apparatus to function as an environment determination unit 1a, a second program code that causes the controller to function as a device driver search unit 1b, and a third program code that causes the controller to function as a device driver install unit 1c.

The controller (to be described later) executes the first program code, the second program code, and the third program code on a virtual environment of the electronic apparatus (image forming apparatus) to operate as the environment determination unit 1a, the device driver search unit 1b, and the device driver install unit 1c, respectively.

Upon activation of the application package 1 on the Java platform 3, the environment determination unit 1a acquires information on a hardware environment (OS 5 version and CPU type) in which the application package 1 is operated.

The device driver search unit 1b selects and specifies out of the device driver group 2, a device driver corresponding to the acquired hardware environment based on the hardware environment table 1e (to be described later).

The device driver install unit 1c installs the specified device driver (e.g., 2a) in the OS 5 using JNI (Java Native Interface) or the like.

Upon installment of the device driver 2a, the native application 4 can access an external device 6 connected to the image forming apparatus via the device driver 2a.

As described above, by merely installing a single application package 1 including a bytecode corresponding to various hardware environments (OS 5 version and CPU type) in the image forming apparatus, a device driver supporting an external device connected to the image forming apparatus can be installed even under various hardware environments of the image forming apparatus.

Heretofore, the general outline has been described.

(Structure of Image Forming Apparatus)

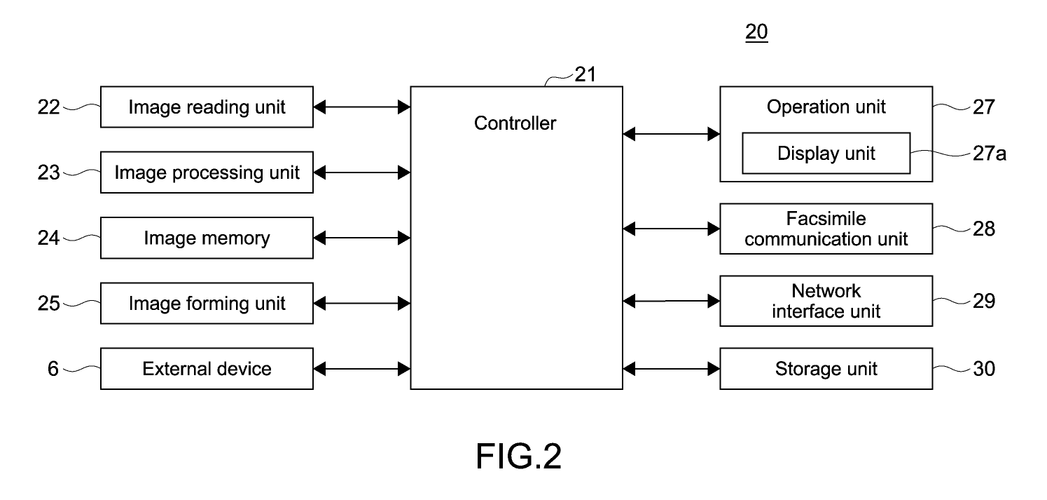

Next, the structure of the image forming apparatus will be described. FIG. 2 shows the structure of the image forming apparatus 20.

The image forming apparatus 20 includes a controller 21. The controller 21 is a processor constituted of a CPU (Central Processing Unit), a RAM (Random Access Memory), a ROM (Read Only Memory), dedicated hardware circuits, and the like and controls overall operations of the image forming apparatus 20. It should be noted that the operating system, the native application, the Java application, the bytecode 1d of the application package 1, and the device drivers are read in the RAM and then executed by the CPU.

The application package 1, the Java platform 3, the native application 4, the OS 5, and the corresponding device driver 2a, 2b, or 2c described in the general outline operate in the controller 21.

The controller 21 is connected to an image reading unit 22, an image processing unit 23, an image memory 24, an image forming unit 25, an operation unit 27, a facsimile communication unit 28, a network interface unit 29, a storage unit 30, and the like. The controller 21 controls operations of the respective units connected thereto and exchanges signals and data with those units.

It should be noted that FIG. 2 shows a state where the external device 6 is connected to the controller 21.

Based on a job execution instruction input by a user via the operation unit 27, a PC connected to a network, or the like, the controller 21 controls drive and processing of mechanisms requisite for executing operational control of functions such as a scanner function, a print function, a copy function, and a facsimile transmission/reception function.

The image reading unit 22 reads an image from a script.

The image processing unit 23 carries out image processing as necessary on image data of an image read by the image reading unit 22. For example, the image processing unit 23 carries out image processing such as shading correction for improving image quality after an image read by the image reading unit 22 is formed.

The image memory 24 is an area that temporarily stores data of a script image read by the image reading unit 22 or data to be printed by the image forming unit 25.

The image forming unit 25 forms an image of image data and the like read by the image reading unit 22.

The operation unit 27 includes a touch panel unit and an operation key unit that accept user instructions on various operations and processing that can be executed by the image forming apparatus 20. The touch panel unit includes a display unit 27a such as an LCD (Liquid Crystal Display) equipped with a touch panel.

The facsimile communication unit 28 includes an encoding/decoding unit, a modulation/demodulation unit, and an NCU (Network Control Unit) (all of which are not shown) and transmits facsimiles using a public telephone network.

The network interface unit 29 is constituted of a communication module such as a LAN board and exchanges various types of data with apparatuses (PC etc.) in a local area via a LAN connected to the network interface unit 29, and the like.

The storage unit 30 is a high-capacity storage apparatus such as an HDD (Hard Disk Drive) that stores a script image read by the image reading unit 22, and the like.

The external device 6 is, for example, an IC card reader latterly attached by a request of a user, and is used by a user authentication program or the like as the native application 4 incorporated as a standard function of the image forming apparatus 20.

Heretofore, the structure of the image forming apparatus 20 has been described.

(Example of Hardware Environment Table)

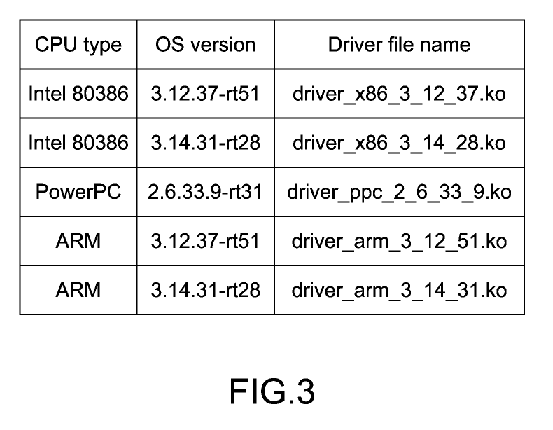

Next, an example of the hardware environment table 1e of the image forming apparatus 20 will be described. FIG. 3 shows the example of the hardware environment table 1e of the image forming apparatus 20.

In the hardware environment table 1e, for example, file names (driver file names and device driver identifiers) of device drivers respectively corresponding to the combinations of the “CPU type” and “OS version” are described.

For example, when the CPU type is ARM (registered trademark) and the OS version is 3.12.37-rt51, the file name of the device driver that is selected as the device driver of the external device 6 is driver_arm_3_12_51.ko.

Further, when the CPU type is PowerPC (registered trademark) and the OS version is 2.6.33.9-rt31, the file name of the device driver that is selected as the device driver of the external device 6 is driver_ppc_2_6_33_9.ko.

Heretofore, the example of the hardware environment table 1e of the image forming apparatus 20 has been described.

(Processing Flow)

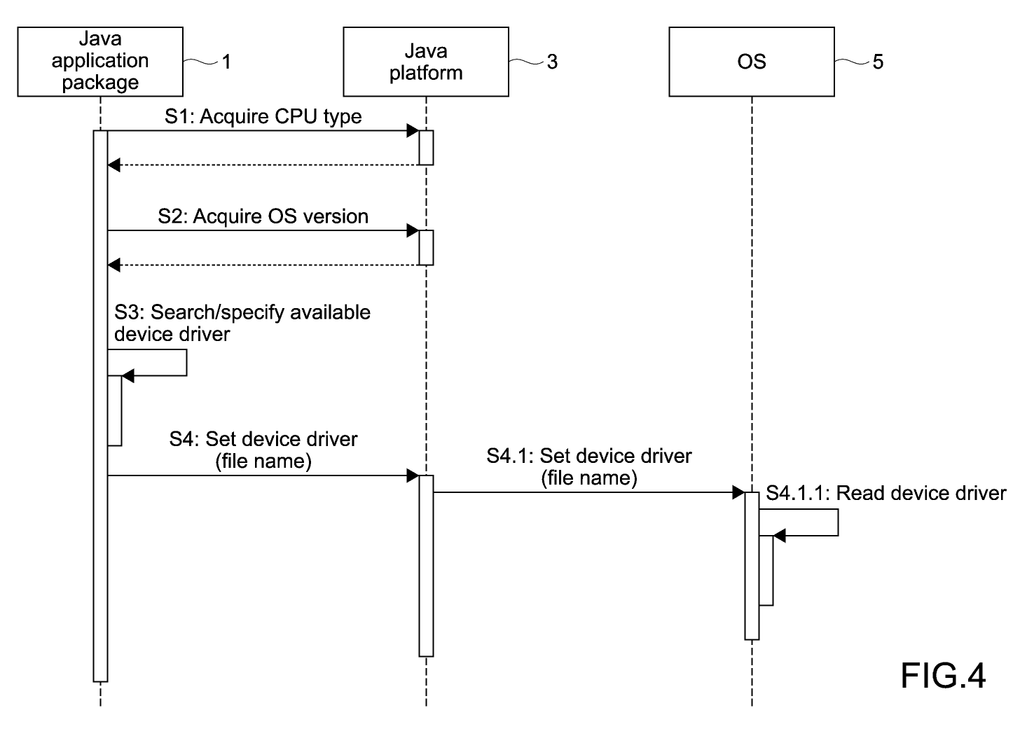

Next, a flow of processing in setting a device driver in the image forming apparatus 20 will be described. FIG. 4 shows processing steps executed when setting a device driver in the image forming apparatus 20.

It should be noted that in this embodiment, it is assumed that a user carries out processing of recognizing what device has been latterly attached to the image forming apparatus 20 as the external device and activating an appropriate application package 1 corresponding thereto on the Java platform 3.

Upon activation of the application package 1, the environment determination unit 1a of the application package 1 first acquires a hardware environment, that is, the CPU type and the OS 5 version, of the image forming apparatus 20 in which the application package 1 is activated, from the Java platform 3 (Steps S1 and S2).

Next, the device driver search unit 1b of the application package 1 searches the hardware environment table 1e using the CPU type and OS 5 version acquired by the environment determination unit 1a and specifies a file name of a device driver corresponding to the hardware environment in which the application package 1 is activated (Step S3).

Next, the device driver install unit 1c of the application package 1 selects, out of the plurality of device drivers 2a, 2b, and 2c incorporated into the application package 1, a file of the file name specified by the device driver search unit 1b and installs it in the OS 5 via the Java platform 3 using a mechanism of JNI or the like (Steps S4, S4.1 and S4.1.1).

Heretofore, the processing flow in setting a device driver in the image forming apparatus 20 has been described.

(Summary)

As described above, according to this embodiment, by merely installing a single package including a bytecode corresponding to various hardware environments, a device driver supporting an external device connected to an electronic apparatus can be installed even under various hardware environments of the electronic apparatus.

Moreover, according to this embodiment, a device driver for directly controlling from the Java application is selected and installed according to the hardware environment (Steps S4, S4.1, and S4.1.1). Therefore, a standard device driver of the OS is not used. As a result, time and effort of cancelling use of the standard device driver and newly installing a device driver for directly controlling from the Java application is not needed.

Moreover, according to this embodiment, the application package 1 includes the plurality of different device drivers 2a, 2b, and 2c, each of which is programmed in a native code corresponding to the environment of a single image forming apparatus. Then, a device driver is selected and installed according to a hardware environment (Steps S4, S4.1, and S4.1.1). Therefore, the external device connected to the image forming apparatus 20 does not need to select an identifier to be supplied to the image forming apparatus 20.

Furthermore, according to this embodiment, the program recorded in the application package 1 together with the device driver group 2 is the bytecode 1d that operates on the Java platform. Accordingly, upon activation of the application package 1, the device driver can be selected and installed according to the hardware environment by the bytecode 1d (Steps S4, S4.1, and S4.1.1).

(Supplementary Note)

In addition, the present disclosure is not limited to the embodiment above and can be variously modified without departing from the gist of the present disclosure.

What is claimed is:

1. A non-transitory computer readable recording medium onto which an application package is recorded,
the application package including
a device driver group including a plurality of different device drivers, each of the device drivers being programmed by a native code in correspondence with each of hardware environments, each of the hardware environments being different for each of electronic apparatuses, each of the device drivers being operated on an operating system of each of the electronic apparatuses, and
a bytecode that is operated on a virtual environment of the electronic apparatus,
the bytecode including
a first program code that causes a processor of the electronic apparatus to acquire information on the hardware environment of the electronic apparatus,
a second program code that causes the processor to search for a device driver corresponding to the acquired hardware environment out of the device driver group, and
a third program code that causes the processor to install the retrieved device driver in the operating system.

2. The non-transitory computer readable recording medium according to claim 1, wherein:
the application package further includes a hardware environment table that describes a plurality of sets of a processor type/operating system version and an identifier of a device driver corresponding to the processor type/operating system version; and
the second program code causes the processor to search for, based on the hardware environment table, a device driver corresponding to the acquired hardware environment out of the device driver group.

3. The non-transitory computer readable recording medium according to claim 1, wherein:
the virtual environment of the electronic apparatus is built based on a Java (registered trademark) platform;
the first program code causes the processor to operate on the Java platform and acquire information on the hardware environment of the electronic apparatus; and
the third program code causes the processor to operate the retrieved device driver on the Java platform and install the device driver in the operating system.

4. The non-transitory computer readable recording medium according to claim 3,
wherein the application package is activated by the Java platform.

5. The non-transitory computer readable recording medium according to claim 3,
wherein the third program code causes the processor to install the retrieved device driver in the operating system using JNI (Java Native Interface) of the Java platform.

6. The non-transitory computer readable recording medium according to claim 1,
wherein the electronic apparatus is an image forming apparatus.

7. The non-transitory computer readable recording medium according to claim 6,
wherein the device driver group includes device drivers, each of the device drivers being used for an HID (Human Interface Device) as an external device connected to the image forming apparatus.

8. An electronic apparatus, comprising:
a processor that executes a bytecode operated on a virtual environment of the electronic apparatus; and
an application package including a device driver group and the bytecode, the device driver group including a plurality of different device drivers, each of the device drivers being programmed by a native code in correspondence with each of hardware environments, each of the hardware environments being different for each of electronic apparatuses, each of the device drivers being operated on an operating system of each of the electronic apparatuses,
the processor operating as, when the bytecode is executed,
an environment determination circuit that acquires information on the hardware environment of the electronic apparatus,
a device driver search circuit that searches for a device driver corresponding to the acquired hardware environment out of the device driver group, and
a device driver install circuit that installs the retrieved device driver in the operating system.
